(19) United States
(12) Patent Application Publication
(10) Pub. No.: US 2005/0259539 A1
(43) Pub. Date: Nov. 24, 2005

(54) Disk reproduction device

(75) Inventor: Futoshi Takeda, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD

(21) Appl. No.: 11/132,314

(22) Filed: May 19, 2005

(30) Foreign Application Priority Data
May 21, 2004 (JP) P2004-152244

(51) Int. Cl. G11B 7/00; G11B 5/09

(52) U.S. Cl. 369/47.55; 369/47.1; 369/53.1; 369/53.45; 369/44.27

(57) ABSTRACT

A control part that controls the device entirety based on an instruction inputted from the operation part has a rezero operation function in that, when an optical pickup reaches the innermost circumferential position of a disk, the control part supplies a thread motor of a thread drive mechanism for moving the optical pickup with a thread drive voltage set to a voltage value and a supply period necessary for moving the optical pickup for a rezero feed distance from a thread drive circuit, whereby moving the pickup 4 toward the disk outer circumferential side, and when the supply period elapses from the point of starting movement of the optical pickup toward the disk outer circumferential side, the control part supplies the thread motor with a rezero brake pulse voltage of 2V through 3V for 17 msec through 25 msec.

### BACKGROUND OF THE INVENTION

1. Field of the Invention

The present invention relates to a disk reproduction device such as a DVD player which reproduces recorded data mainly read from a DVD (digital versatile disk), displays video signals of the recorded data as images on a screen display part, and outputs audio signals from a speaker.

2. Description of the Related Art

Generally, a disk called a short track disk (for example, a DVD-RW) belonging to the above-mentioned DVDs records specific data on its disk innermost circumferential portion. When reproducing this short track disk, to readout the specific data, when a power supply is turned on, a so-called rezero operation is carried out in which a pickup is temporarily moved to the disk innermost circumferential position and then moved toward the disk outer circumferential portion and positioned and stopped at a predetermined reading start position (hereinafter, referred to as a rezero position).

The rezero operation in a conventional disk reproduction device is described with reference to the timing chart of FIG. 5A and 5B. FIG. 5A shows the thread drive voltage to be supplied to a thread motor as a drive source for moving the optical pickup at the time of rezero operation, and FIG. 5B shows the movement of the optical pickup. First, when the power supply of the disk reproduction device is turned on in timing to, the thread motor rotates in reverse by being supplied with a negative thread drive voltage as shown in FIG. 5A, whereby the optical pickup is moved to the disk inner circumferential side as shown in FIG. 5B. When the optical pickup moving toward the inner circumferential side mechanically turns an inner circumferential limit switch on in timing t₁, in response to a detection signal thereof, a system controller judges that the optical pickup has reached the disk innermost circumference, and supplies a positive brake voltage shown in FIG. 5A to the thread motor for a period from t₁ to t₂, whereby the optical pickup is temporarily stopped at the innermost circumferential position.

Next, after standby for a predetermined period from t₂ to t₃, the thread motor is supplied in timing t₃ with a thread drive voltage that is set in advance to a voltage value and a supply period (from t₃ to t₄) necessary for moving the optical pickup for the predetermined rezero feed distance (moving distance from the disk innermost circumferential position to the rezero position of the disk outer circumferential side). Thereby, the optical pickup is moved from the disk innermost circumferential position toward the disk outer circumferential side and positioned and stopped at the rezero position.

In addition, as a related art relating to thread driving, the following are available. Namely, a thread drive control method as a first related art has been proposed, wherein, in an optical disk device, a gain correction amount is calculated which minimizes the deflection amount of an objective lens inside the optical pickup when track jumping, and the thread jumping gain corresponding to each jumping number is corrected based on this gain correction amount, the thread movement is controlled by using the corrected thread jumping gain, whereby stable track jumping becomes possible (for example, refer to JP-A-7-235067).

In addition, a second related art is disclosed in which, in a disk reproduction device which slides the optical pickup and then supplies a voltage for reverse rotation to the thread motor to apply a braking force for braking, a pulse width is detected from a track cross signal, and from a signal of the pulse width, the moving speed of the sliding portion loaded with the optical pickup is calculated and an additional braking period is set (for example, refer to JP-A-2001-184813).

Furthermore, in a third related art, in a random-access device for a CD player, means for pre-setting a number of tracks to be jumped for reaching a target position, measuring a number of tracks that the optical pickup crosses when jumping, pre-setting a maximum jumping period including a margin according to the number of tracks to be jumped, starting measuring at the same time as jumping, and when the measured value of the track number measuring means reaches the pre-set value, generating brake pulses for only the period corresponding to the pre-set value has been proposed (for example, refer to JP-A-7-169066).

### SUMMARY OF THE INVENTION

However, in the control means for the rezero operation in the conventional disk reproduction device, after the optical pickup reaches the disk innermost circumferential position, the thread motor is supplied with a thread drive voltage set in advance to a predetermined voltage value and a predetermined supply period to move the optical pickup for a predetermined rezero feed distance, so that due to influence from variation of the minimum starting voltage (a minimum thread drive voltage necessary for moving the optical pickup via the thread drive mechanism) among thread motors, the rezero feed distance also varies, that is, the rezero position at which the pickup is positioned and stopped after rezero-feeding varies.

Namely, when the minimum starting voltage is as high as, for example, 1.0V, the feed motor easily stops its rotation, so that the rezero feed distance becomes short as shown by the alternate long and two short dashed line in timing t₄ of FIG. 5B, and to the contrary, when the minimum starting voltage is as small as, for example, 0.4V, the feed motor continues inertial rotation and does not readily stop, so that the rezero feed distance becomes long as shown by the solid line in timing t₄ of FIG. 5B. When the rezero position thus varies, later searching for a predetermined track becomes impossible and may cause an error.

On the other hand, any of the conventional three thread driving related techniques do not relate to the rezero operation, so that these cannot be applied to solve the above-mentioned problem of variation in rezero feed distance caused by variation of the minimum starting voltage among feed motors.

Therefore, the invention was made in view of the above-described conventional problem, and an object thereof is to provide a disk reproduction device which can accurately position and stop the optical pickup at a predetermined rezero position without fail without being influenced by variation of the minimum starting voltage among thread motors.

In order to achieve the above-mentioned object, a DVD player according to a first aspect of the invention carries out a rezero operation in which an optical pickup is temporarily moved to the innermost circumferential position of a disk, and then moved for a predetermined rezero feed distance toward the disk outer circumferential side and positioned and stopped at a rezero position when a power supply is turned on, wherein a control part which controls the entirety of the player based on an instruction inputted by operation on an operation part, has a rezero operation control function for moving the optical pickup toward the disk outer circumferential side by supplying, from a thread drive circuit, a thread motor of a thread drive mechanism that moves the optical pickup with a thread drive voltage set to a voltage value and a supply period necessary for moving the optical pickup for the rezero feed distance when the optical pickup reaches the disk innermost circumferential position, and for controlling so as to supply the thread motor with a rezero brake pulse voltage of 2V through 3V for 17 msec through 25 msec when the supply period elapses from the point of starting movement of the optical pickup toward the disk outer circumferential side.

A disk reproduction device according to a second aspect of the invention carries out a rezero operation in which an optical pickup is temporarily moved to a disk innermost circumferential position when a power supply is turned on, and then moved for a predetermined rezero feed distance toward the disk outer circumferential side and positioned and stopped at a rezero position, wherein a control part which controls the entire device based on an instruction inputted by operation on an operation part, has a rezero operation control function for moving the optical pickup toward the disk outer circumferential side by supplying, from a thread motor circuit, a thread motor of a thread drive mechanism that moves the optical pickup with a thread drive voltage set to a voltage value and a supply period necessary for moving the optical pickup for the rezero feed distance when the optical pickup reaches the disk innermost circumferential position, and for controlling so as to supply the thread motor with a rezero brake pulse voltage with a predetermined voltage value for a predetermined supply period when the supply period elapses from the point of starting movement of the optical pickup toward the disk outer circumferential side.

In a disk reproduction device according to a third aspect of the invention, the rezero brake pulse voltage in the disk reproduction device according to the second aspect of the invention is set so as to be supplied at a voltage value of 2V through 3V for a period of 17 msec through 25 msec, more preferably, at a voltage value of 2.5V for 20 msec.

According to the first aspect of the invention, regardless of variation of the minimum starting voltage among thread motors, the optical pickup can be stopped without fail in the timing of supply of the rezero brake pulse voltage to the thread motor, so that the optical pickup can be correctly positioned and stopped at a target rezero position moved to the disk outer circumferential side for a predetermined rezero feed distance from the innermost circumferential position. In addition, the rezero brake pulse voltage is set so as to be supplied at a voltage value in a range between −2V and −3V for a supply period of 17 msec through 25 msec, and this eliminates the possibility that the optical pickup temporarily stopped at the rezero position goes back to the inner circumferential side, and in particular, by supplying a pulse with a voltage value of −2.5V for a period of 20 msec through 25 msec as the rezero brake pulse voltage, regardless of variation of the minimum starting voltage among feed motors, the optical pickup can be correctly positioned and stopped at a predetermined rezero position without fail.

According to the second aspect of the invention, regardless of variation of the minimum starting voltage among feed motors, the optical pickup can be positioned and stopped in timing of supply of the rezero brake pulse voltage to the thread motor, so that the optical pickup can be accurately positioned at a target rezero position moved to the disk outer circumferential side for a predetermined rezero feed distance from the innermost circumferential position.

According to the third aspect of the invention, the rezero brake pulse voltage is set so as to be supplied at a voltage value in a range between −2V and −3V for a supply period of 17 msec through 25 msec, and this eliminates the possibility that the optical pickup temporarily stopped at the rezero position goes back to the inner circumferential side, and in particular, by supplying a pulse with a voltage value of −2.5V for 20 msec through 25 msec as the rezero brake pulse voltage, regardless of variation of the minimum starting voltage among feed motors, the optical pickup can be accurately stopped at a predetermined rezero position without fail.

### BRIEF DESCRIPTION OF THE DRAWINGS

FIG. 1 is a block diagram showing a disk reproduction device relating to an embodiment of the invention.

FIG. 2 is an electrical circuit diagram showing a thread drive circuit in the same disk reproduction device.

FIGS. 3A and 3B are timing charts showing a rezero operation in the same disk reproduction device, wherein FIG. 3A shows a thread drive voltage, and FIG. 3B shows the movement of the optical pickup.

FIG. 4 is a flowchart showing control processing in the rezero operation in the same disk reproduction device.

FIGS. 5A and 5B are timing charts showing a rezero operation in a conventional disk reproduction device, wherein FIG. 5A shows a thread drive voltage, and FIG. 5B shows the movement of the optical pickup.

### DESCRIPTION OF THE PREFERRED EMBODIMENTS

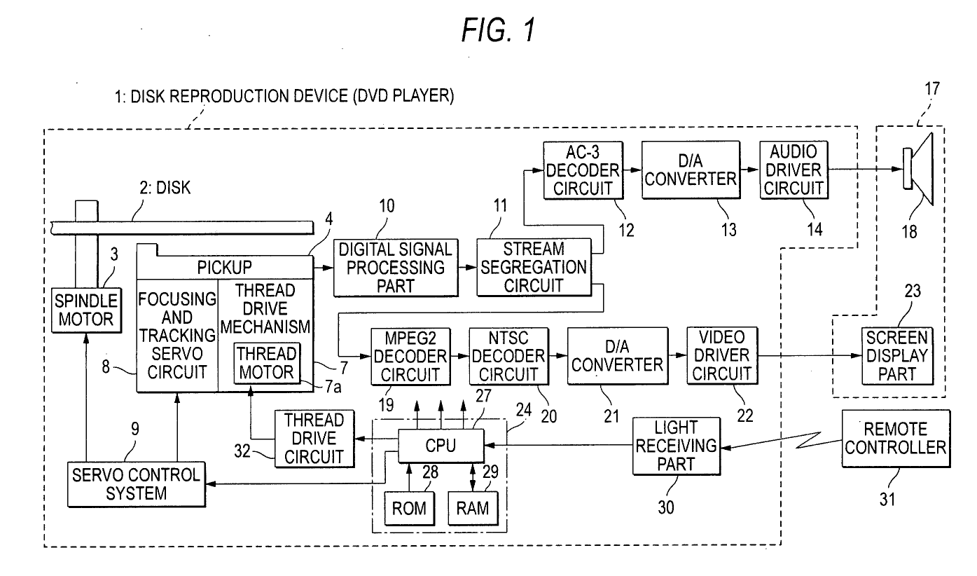

Hereinafter, a preferred embodiment of the invention is described in detail with reference to the drawings. FIG. 1 is a block diagram showing a disk reproduction device 1 according to an embodiment of the invention, and in this embodiment, a DVD player is illustrated. In the same figure, recorded data recorded on the disk 2 of a DVD is read out by the optical pickup 4 while the disk 2 is rotated by the spindle motor 3. The optical pickup 4 is equipped in the thread drive mechanism 7 using the thread motor 7a as a drive source, and moved horizontally in the disk radius direction of the disk 2 by the thread drive mechanism 7 according to the rotation of the thread motor 7a. The optical pickup 7 is provided with a focusing servo and tracking servo circuit 8 for controlling the position of an objective lens (not shown). The spindle motor 3 and the focusing servo and tracking servo circuit 8 are controlled by the servo control system 9.

Based on the intensity of light reflected from the disk 2, an RF signal as recorded data read out by the optical pickup 4 is converted into digital data by an RF amplifier that is not shown, and inputted into the digital signal processing part 10. At the digital signal processing part 10, processing such as error correction is applied to the inputted digital data, and then the data is outputted to the stream segregation circuit 11.

The stream segregation circuit 11 segregates digital data supplied from the digital signal processing part 10 into bit streams of video and audio sub-pictures. The segregated audio bit stream is inputted to the AC-3 decoder circuit 12. The audio bit stream is compressed and encoded according to the AC-3 format, and in the AC-3 decoder circuit 12, the audio bit stream is expanded and decoded, whereby the audio bit stream is converted into a digital audio signal.

The digital audio signal thus obtained is inputted into the D/A converter 13 from the AC-3 decoder circuit 12 and D/A converted. The converted analog audio signal is outputted to the speaker 18 of a TV receiver 17 via the audio driver circuit 14 and reproduced and outputted as audible sounds from the speaker 18.

On the other hand, the video bit stream segregated by the stream segregation circuit 11 is inputted into the MPEG2 decoder circuit 19. This video bit stream is compressed and encoded according to the MPEG2 format, and in the MPEG2 decoder circuit 19, the video bit stream is expanded and decoded, whereby the video bit stream is converted into a digital video signal. The digital video signal is inputted into the NTSC decoder circuit 20. The NTSC decoder circuit 20 converts the inputted digital video signal into a digital video signal indicating an NTSC-format video image, and this digital video signal is D/A converted by the D/A converter 21. This converted analog video signal is outputted to a screen display part 23 such as a cathode-ray tube, a liquid crystal display panel or a plasma display panel, of the TV receiver 14, via a video driver circuit 22 and is displayed as an image on the screen display part 23.

The system controller 24 controls the entire system based on various remote-controller control commands inputted by key operations on a remote controller 31 by an operator. Namely, the CPU 27 of the system controller 24 reads various control programs and application programs stored in the ROM 28 upon receiving a remote-controller control command sent as an infrared ray signal from the remote controller 31 via the light receiving part 30, temporarily stores these in a program storing region in the RAM 29, executes various control processings instructed by the remote-controller control command, and temporarily stores various data generated by this control processing in the RAM 29.

For example, when judging that the power supply is turned on, by controlling and rotating the thread motor 7a via the thread drive circuit 32, the CPU 27 controls to carry out a rezero operation so as to position and stop the optical pickup 4 at a rezero position by moving it toward the outer circumferential side after temporarily moving the optical pickup to the disk innermost circumferential portion, and when receiving a remote-controller control command that instructs reproduction from the remote controller 31, the CPU controls and rotates the spindle motor 3 via the servo control system 9 and controls the position of the objective lens via the focusing servo and tracking servo circuit 8. Thereby, the optical pickup 4 reads recorded data from the head of the data region of the disk 2 while being horizontally moved toward the disk radial outer circumferential side from the rezero position of the disk 2.

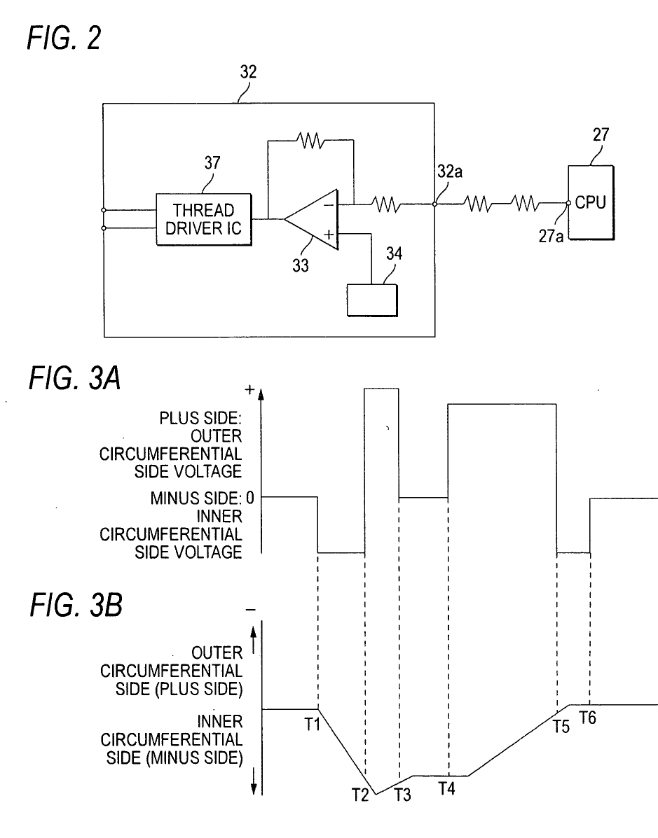

FIG. 2 is an electrical circuit diagram showing the thread drive circuit 32. From the thread-parameter signal output terminal 27a of the CPU 27 in the system controller 24 of FIG. 11, a thread drive control signal variably controlled based on a program stored in the ROM 28 is outputted to the thread signal input terminal 32a of the thread drive circuit 32. In the thread drive circuit 32, the thread drive control signal is inputted into a negative inverting input terminal of the operational amplifier 33 having a positive non-inverting input terminal to which a reference voltage set in advance by the reference voltage generator 34 is inputted, and then amplified to a set amplification level.

The thread driver IC 37 to which the amplified signal is inputted generates a positive-side thread drive voltage and a negative-side thread drive voltage by two inverting and non-inverting amplifier circuits (not shown), and outputs and supplies the positive-side thread drive voltage and the negative-side thread drive voltage from the positive-side thread output terminal 32b and the negative-side thread output terminal 32c to the thread motor 7a of FIG. 1. The thread motor 7a rotates in reverse or forward based on a voltage difference between the supplied positive-side thread drive voltage and negative-side thread drive voltage to move the optical pickup 4 horizontally toward the disk inner circumferential side or the disk outer circumferential side via the thread drive mechanism 7.

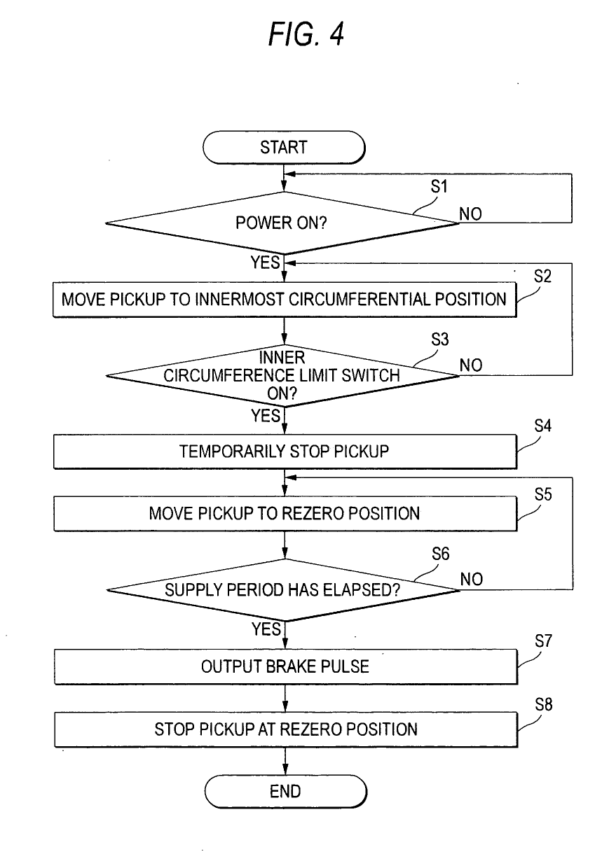

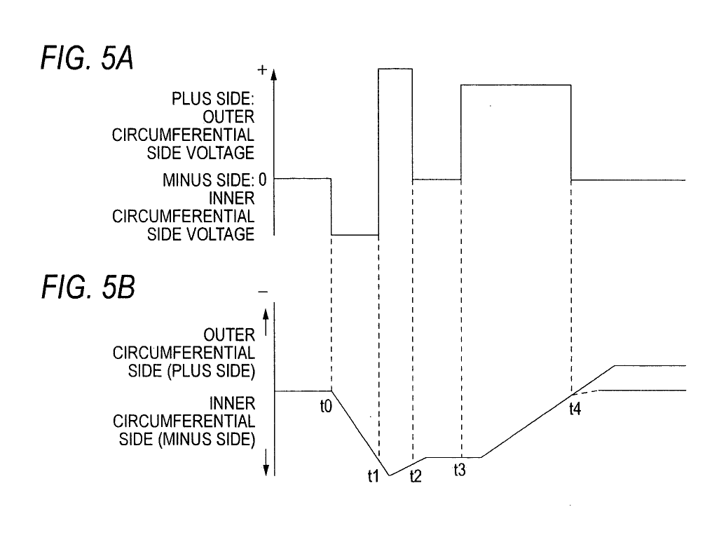

Next, the rezero operation in the disk reproduction device 1 is described with reference to the timing chart of FIGS. 3A and 3B and the flowchart of FIG. 4. FIG. 3A shows a tread drive voltage to be supplied to the thread motor 7a when the rezero operation is carried out, and FIG. 3B shows the movement of the optical pickup 4.

In FIG. 4, the CPU 27 always monitors turning-on of the power supply (step S1), and when it judges that the power supply has been turned on in timing T₁ of FIGS. 3A and 3B, the CPU outputs a thread drive control signal which provides the negative thread drive voltage as shown in FIG. 3B as a voltage difference between the positive-side thread drive voltage and the negative-side thread drive voltage outputted from the positive-side and negative-side thread output terminals 32b and 32c, respectively, and rotates the thread motor 7a in reverse, whereby causing to move the optical pickup 4 toward the disk innermost circumferential position as shown in FIG. 3B (step S2).

Next, the CPU 27 monitors whether or not a detection signal has been inputted from the inner circumference limit switch (not shown) in response to mechanical turning-on of the inner circumferential limit switch by the optical pickup 4 moving to the disk inner circumferential side (step S3), and when a detection signal is inputted from the inner circumference limit switch in timing T₂ of FIGS. 3A and 3B, the CPU judges that the pickup 4 has reached the innermost circumferential position and outputs a thread drive control signal which makes the positive brake voltage as shown in FIG. 3A to be supplied to the thread motor 7a for a period from T₁ to T₂ to the thread drive circuit 32, whereby causing to temporarily stop the optical pickup 4 at the innermost circumferential position (step S4).

Next, the CPU 27 stands by for a predetermined period from T₂ to T₃, and then outputs a thread drive control signal which makes it possible to supply the thread motor 7a with a thread drive voltage set in advance to a positive voltage value and a supply period (between T₃ and T₄) necessary for moving the optical pickup for a predetermined rezero feed distance toward the outer circumferential side, and moves the optical pickup 4 from the disk innermost circumferential position toward the outer circumferential side (step S5). The voltage value and the supply period are set as conventionally. Thereafter, the CPU 27 monitors the elapse of the supply period (step S6), and when it judges that the predetermined period has elapsed, the CPU outputs a thread drive control signal that enables supply of a negative rezero brake pulse voltage as shown in FIG. 3A to the thread motor 7a, to the thread drive circuit 32 (step S7).

Thereby, regardless of variation of the minimum starting voltage among feed motors 7a, at the point when the rezero brake pulse voltage is supplied to the thread motor 7a, that is, at a target rezero position moved toward the disk outer circumferential side for a predetermined rezero feed distance from the disk innermost circumferential position, the optical pickup 4 is accurately stopped (step S8). Namely, when the minimum starting voltage of the feed motor 7a is comparatively high, regardless of supply of the rezero brake pulse voltage, that is, even if no rezero brake pulse voltage is supplied, the rezero feed distance hardly varies, and on the other hand, when the minimum starting voltage of the feed motor 7a is comparatively small, the thread motor 7a tries to continue inertial rotation, however, this inertial rotation of the thread motor 7a is immediately stopped by supply of the rezero brake pulse voltage. As a result, the optical pickup 4 is stopped at the predetermined rezero position moved toward the disk outer circumferential side for a predetermined rezero feed distance from the disk innermost circumferential position without fail regardless of variation of the minimum starting voltage among feed motors 7a.

However, the rezero brake pulse voltage must be set so as to be supplied at a voltage value for a supply period which makes the optical pickup 4 to stop at a predetermined rezero position without fail regardless of variation of the minimum starting voltage among feed motors 7a and prevents the optical pickup 4 stopped at the rezero position from going back toward the inner circumferential side. As such a rezero brake pulse voltage, setting within −4V does not cause the optical pickup 4 to go back to the inner circumferential side, and preferably, the voltage is set in a range between −2V and −3V and supplied for a period of 17 msec through 25 msec. Most preferably, according to the results of actual measurement made by the inventor of this invention, it was found that supply of a pulse with a voltage of 2.5V for 20 msec through 25 msec could make the optical pickup 4 to accurately stop at a predetermined rezero position without fail regardless of variation of the minimum starting voltage among feed motors 7a.

Therefore, in the rezero operation described above, the rezero brake pulse voltage set so as to be supplied at a predetermined voltage value for a predetermined supply period is only supplied without detecting the variation of the minimum starting voltage among feed motors 7a, and this requires no complicated control processing. According to this, in this disk reproduction device, only by changing a part of the control program of the system controller 24, it becomes unnecessary to add a new hardware configuration such as circuits to the existing construction, and this prevents high costs.

In this disk reproduction device which reproduces a short track disk such as a DVD-RW, in rezero operations, regardless of variation of the minimum starting voltage among feed motors, the optical pickup can be accurately positioned and stopped without fail at a target rezero position moved toward the disk outer circumferential side for a predetermined rezero feed distance from the disk innermost circumferential position, whereby a disk reproduction device is provided which can solve conventional problems in that variation of the rezero position disables the predetermined track search and causes errors.

1. A DVD player which carries out a rezero operation in which an optical pickup is temporarily moved to an innermost circumferential position of a disk when a power supply is turned on, and then moved for a predetermined rezero feed distance toward the disk outer circumferential side and positioned and stopped at a rezero position, the DVD player comprising:
a control part controlling an entirety of the DVD player based on an instruction inputted by operation on the operation part,
wherein the control part has a rezero operation control function for moving the optical pickup toward the disk outer circumferential side by supplying, from a thread drive circuit, a thread motor of a thread drive mechanism that moves the optical pickup with a thread drive voltage set to a voltage value and a supply period necessary for moving the optical pickup for the rezero feed distance when the optical pickup reaches the disk innermost circumferential position, and
for controlling to supply the thread motor with a rezero brake pulse voltage of 2V through 3V for 17 msec through 25 msec in a decelerating direction of the optical pickup when the supply period elapses from the point of starting movement of the optical pickup toward the disk outer circumferential side.

2. A disk reproduction device which carries out a rezero operation in which an optical pickup is temporarily moved to a disk innermost circumferential position when a power supply is turned on, and then moved for a predetermined rezero feed distance toward the disk outer circumferential side and positioned and stopped at a rezero position, the disk reproduction device comprising:
a control part which controls the entire device based on an instruction inputted by operation on an operation part, wherein the control part has a rezero operation control function for moving the optical pickup toward the disk outer circumferential side by supplying, from a thread drive circuit, a thread motor of a thread drive mechanism that moves the optical pickup with a thread drive voltage set to a voltage value and a supply period necessary for moving the optical pickup for the rezero feed distance when the optical pickup reaches the disk innermost circumferential position, and for controlling so as to supply the thread motor with a rezero brake pulse voltage with a predetermined voltage value for a predetermined supply period when the supply period elapses from the point of starting movement of the optical pickup toward the disk outer circumferential side.

3. The disk reproduction device according to claim 2, wherein the rezero brake pulse voltage is set to be supplied at a voltage value of 2V through 3V for a period of 17 msec through 25 msec,

4. The disk reproduction device according to claim 3, wherein the rezero brake pulse voltage is set to be supplied at a voltage value of 2.5V for 20 msec.
